(19) United States
(12) Patent Application Publication
(10) Pub. No.: US 2007/0118319 A1
(43) Pub. Date: May 24, 2007

(54) System and method for testing control processes in a vehicle

(76) Inventors: Mathias Pillin, Stuttgart (DE); Martin Lehr, Kusterdingen (DE); Frank Traenkle, Erdmannhausen (DE); Thomas Schmerler, Wiernsheim-Iptingen (DE); Juergen Meyer, Dusslingen (DE)

Correspondence Address: KENYON & KENYON LLP, ONE BROADWAY, NEW YORK, NY, 10004, US

(21) Appl. No.: 10/574,051

(22) PCT Filed: Sep. 3, 2004
(86) PCT No.: PCT/DE04/01955

§ 371 Date: Jan. 16, 2007

(30) Foreign Application Priority Data
Sep. 23, 2003 (DE) 103 45 615.5

(51) Int. Cl. G06F 19/00; G01M 17/00

(52) U.S. Cl. 702/108; 701/29

(57) ABSTRACT

System for testing control processes in a vehicle, including a simulation model which responds to the control processes to be tested, experiment software being superimposed upon the simulation model, and a signal pattern being formed between the experiment software and a component triggering the signal pattern; the signal pattern being divided into at least two signals by at least two intervention points, and at least one identifier being provided that enables the signals to be assigned to the signal pattern.

### FIELD OF THE INVENTION

The present invention is directed to a system for testing control processes in a vehicle not known from the related art.

### BACKGROUND INFORMATION

Driving a car is becoming more comfortable, safer and more environmentally compatible, in particular thanks to what are known as embedded controllers. However, these systems also make the vehicle more complex and the tests needed to ensure operational reliability more comprehensive, which simultaneously extends the development cycles. Due to competition, however, automakers need to place complex, smoothly functioning systems on the market as quickly as possible.

In particular, tests of electronic components, in particular control units and their software, are becoming increasingly more important. To achieve a deeper level of testing, while simultaneously shortening development cycles, the tests must be largely shifted from the road to the laboratory as well as standardized and automated. Satisfying this requirement means using modem development and testing methods as well as optimum tool support such as LabCar from ETAS GmbH, a hardware-in-the-loop test system according to the “LabCar” white paper of 1999, release October 1999, by ETAS GmbH & Co. KG, Stuttgart.

The present invention described below is intended to improve and optimize this situation in test systems with regard to control processes in a vehicle, in particular in the case of hardware-in-the-loop test systems like LabCar.

### SUMMARY OF THE INVENTION

The system and the method for testing control processes in a vehicle, as well as a computer program and computer program product are based on a simulation model which responds to the control processes to be tested, experiment software being advantageously superimposed upon the simulation model and a signal pattern being formed between the experiment software and a component triggering the control processes, the signal pattern being divided into at least two signals by at least two intervention points, and at least one identifier being provided which enables the signals to be assigned to the signal pattern.

In a test system used to validate developments in the area of automotive electronics, this advantageously enables the signal flow or signal pattern to be visualized via the test system and via the object to be validated, the values of these signals detected during a test to be displayed and certain types of intervention into the signal pattern to be enabled.

Either the intervention points themselves or the signals produced by the intervention points are expediently provided with identifiers.

The resulting signals are advantageously assigned to different signal groups, and these different signal groups or the signals assigned to them are expediently displayed visually.

As a result, not only the signal pattern or signal flow may be displayed by the test system, but also the values of these signals detected during a test, or the signals or their values corresponding to the intervention points.

The identifiers in the system are expediently provided with a variable design so that the signals may be assigned to different signal patterns, in particular during the test, which makes it possible to represent optimized test scenarios.

It is possible in a particularly advantageous manner to input into the signal pattern a signal which replaces a signal of this type at least one intervention point, for example a signal output by a signal generator or a constant value that replaces the original signal, in the course of a desired test scenario.

The object of the present invention is therefore to visualize the signal patterns connected to the components triggering the control processes within the test system, to display the values of the signals and to provide the user with additional functions so that the user may efficiently set up and operate the test system.

### BRIEF DESCRIPTION OF THE DRAWINGS

FIG. 1 shows a schematic representation of a control or regulating system within the driver-vehicle-environment complex.

FIG. 2 shows a development diagram of the test system according to the present invention.

FIG. 3 shows a schematic representation of a signal pattern or signal flow in a test system having intervention points.

FIG. 4 shows a signal or signal value display table according to the present invention.

FIG. 5 shows a possible identifier implementation according to the present invention by using an identifier diagram.

### DETAILED DESCRIPTION

Electronic components and software are becoming increasingly more important in the development of new generations of vehicles. They are used to lower costs and simultaneously gain a competitive advantage with consumers.

The object of the present invention is the development and validation of components triggering control processes in a vehicle, in particular electronic control or regulating systems or regulators in automotive engineering. The validation of these controllers is an altogether complex process that is impossible to carry out without the use of special tools. These tools, or test systems, are intended to enable simulation of the vehicle in the laboratory through different steps in the development process and thereby give the electronic controller or the regulator the impression that it is installed in a real vehicle.

A regulator of this type typically has a very large number of interfaces, i.e., inputs and outputs, which are coupled to, and therefore interact with, other components in the vehicle. In a test system intended to simulate the behavior of a real vehicle, these interfaces form a highly complex system that is hard for users to operate. The present invention and its various embodiments should be viewed against this background. The object of the present invention is therefore to enable a user to maintain an overview of the system complexity and also to boost efficiency in using the system on a daily basis. Software and software products that are used for controlling an experiment in a test system may thus be improved.

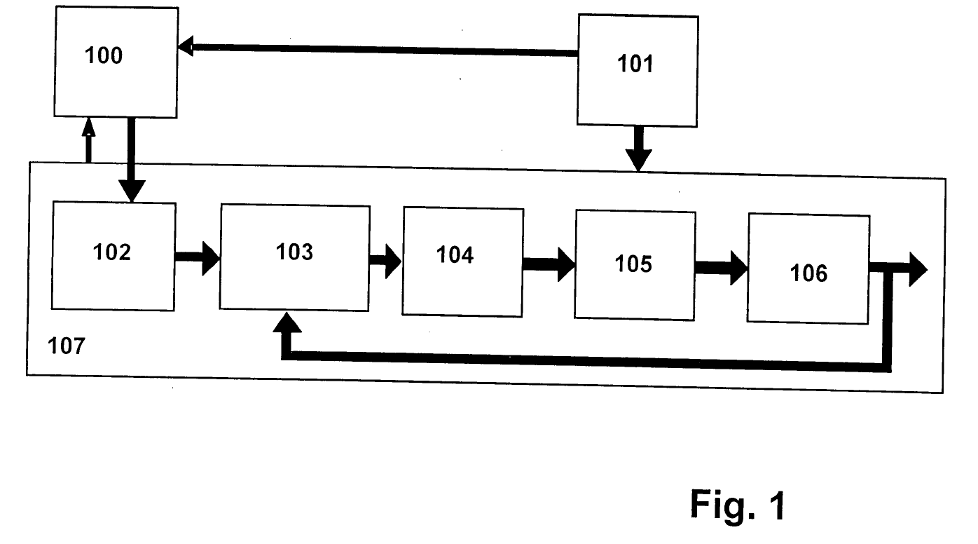

In developing components which trigger control processes, in particular electronic control and regulating systems in automotive engineering, the signal flow may be illustrated on the basis of the diagram shown in FIG. 1. Individual elements are represented by blocks and the signal flows existing between them as arrows. Reference numeral 107 symbolizes the vehicle itself. Block 100 represents the driver, and block 101 the environment. As shown in FIG. 1, a large number of signal flows may exist between the vehicle, driver, and environment components. In this illustration, the driver is also representative of all other users of a vehicle function, for example additional passengers. The environment also includes other vehicles or electronic systems in the area around the vehicle, for example tools such as diagnostic testers, which are connected to the vehicle's electronic systems in the service shop. This logical system architecture for controlling, regulating and monitoring systems according to FIG. 1 symbolizes the following sequence. The driver operates levers or switches in the vehicle, e.g., a turn signal lever or gas pedal. This driver request is forwarded to controller 103, i.e., one of the components triggering the control processes, via setpoint value generator 102. Controller 103 processes this information and activates actuators 104. For example, if the driver wants to accelerate, the controller controls injection valves and the throttle valve so that more fuel is supplied to the combustion chamber. Controlled system 105 is a part of the vehicle which processes the actuator's action, for example the cylinder that burns fuel and passes the generated torque on to the vehicle. Finally, sensors 106 are needed to detect the behavior of the vehicle or individual components. For example, once the speed desired by the driver has been reached, this speed is detected by a sensor. The sensor forwards the information it has detected to the controller so that the latter may respond thereto. The driver then perceives the vehicle's behavior and will subsequently influence it again. Of course, environment 101 also influences the vehicle and the driver, for example through external temperature or road surface, weather conditions such as rain, snow or wind, etc. The arrows in FIG. 1 thus represent the signal flow in the manner described above by way of example.

The functions of a test system are as follows:

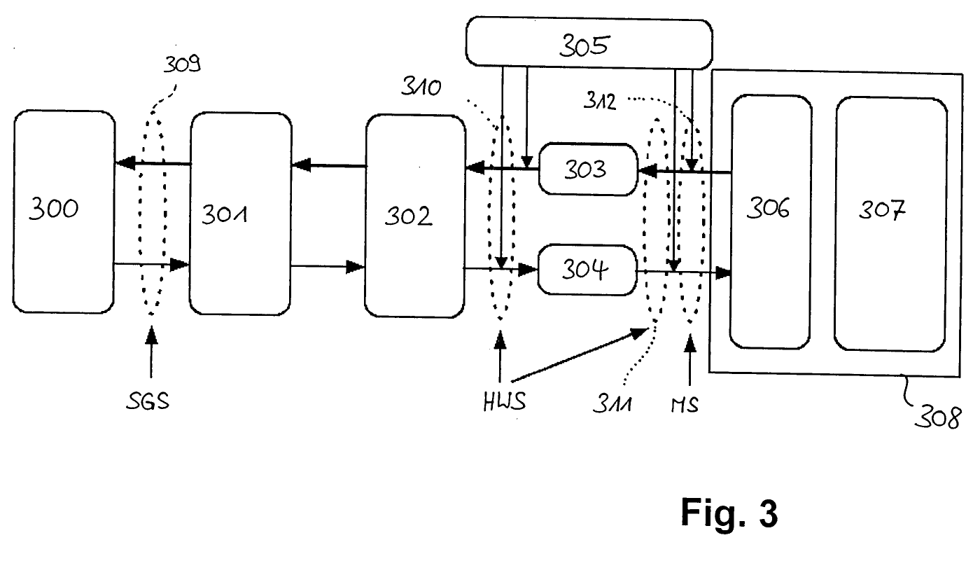

A system for testing control processes in a vehicle must be able to simulate all units shown in FIG. 1, except for the controller itself. This may be done through software or, in some applications, also requires the use of special electronics, hardware that supplies the control unit, for example with the same electrical control signals that would occur in a real vehicle. In this case, the scope of the underlying simulation model which simulates the units or components in FIG. 1 depends on the use of this hardware. According to the present invention, the test system is equipped with software; experiment software is thus superimposed in the simulation model, enabling the user to do the following: configure the system, i.e., make basic settings of the simulation model and any hardware that may be used, and also place the controller into operation, since modern controllers are often equipped with extensive diagnostic functions. These functions should determine whether the controller is being supplied with implausible signals. If such cases occur, the controller switches to an emergency operating mode which causes a test carried out using the test system to be no longer unconditionally relevant. This means that the experiment software must help the user perform a simulation in which the controller does not switch directly to an emergency operating mode of this type, and in which an interactive test is carried out, which means that the experiment software must have a functionality that enables the user to interact with the test system via a control PC, and finally to record and manage data that accumulates during a test. The position of this experiment software and the interaction, i.e., the resulting signal flow or the signal patterns, are illustrated in greater detail below in FIG. 3.

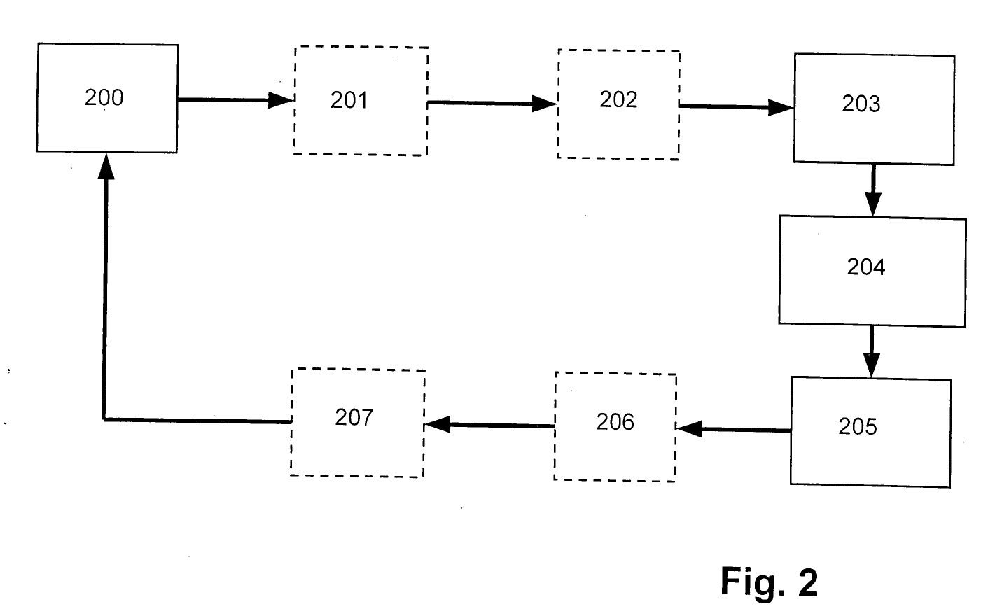

On the basis of FIG. 1, a user typically has the view of the test system shown in FIG. 2. In this figure, block 200 represents a controller, block 201 the signal detector, block 202 static actuator models, and block 203 dynamic actuator models. Block 204 shows a model of the controlled system, driver and environment, downstream from which are block 205 (dynamic sensor models), block 206 (static sensor models), and block 207 (signal generator). Controller 200 typically has any number of inputs and outputs. The diagram shown in FIG. 2 is viewed in a clockwise direction, starting with controller 200. The output signals of the controller are detected by an optional signal detector. If the controller is provided as a physical object, signal detector 201 is, for example, a hardware component. It is followed by a further optional unit which converts the electrical signals to physical units, e.g., a voltage to a temperature. The dynamic behavior of the actuator in the test system is subsequently simulated in block 203. This is followed by a simulation of the driver, environment, and the rest of the vehicle before the signal pattern is supplied back to controller 200 via units for generating signals, i.e., a dynamic sensor model 205, a static sensor model 206, and a signal generator 207.

The blocks or units shown in FIG. 2 are typically implemented in different tools. The controller itself may be provided either as a physical object or as a model in a simulation tool. Likewise, signal detector 201 and signal generator 207 blocks may be provided as electronic components, i.e., as hardware, or implemented in a simulation tool. The remaining blocks in FIG. 2 are typically provided in a simulation tool. The simulation model therefore includes at least the controlled system, driver, and environment model as well as the dynamic actuator models and the dynamic sensor models, i.e., blocks 203 through 205 in FIG. 2.

A problem arises in the fact that the signal pattern shown in FIG. 2 is not unambiguous. Instead, an output signal of the controller may be switched to multiple signal detection channels, which in turn are connected to multiple static actuator models, etc. Furthermore, the user of the test system is confronted with another problem in that the aforementioned simulation tools may vary. This means, for example, that dynamic actuator models 203 are implemented in a tool A, while the static actuator models are provided in a tool B.

To enable the user of the test system to work efficiently, a further software layer, referred to below as the experiment software, is typically positioned over the structure shown in FIG. 2, making it possible to conduct an experiment for testing the controller. This means that the user is provided with ways to access objects, i.e., parameters or measured quantities supplied by the objects in FIG. 2.

The core of the present invention is based on the fact that a method is implemented which automatically detects the interfaces of the blocks illustrated in FIG. 2 and the interconnections between these blocks, which are generally not unambiguous, and inputs them into the experiment software layer defined above. These interfaces are further provided with intervention points having identifiers which are then used in the experiment software. Instead of providing the intervention points with identifiers, it is also possible to provide the signals generated by the intervention points, as shown in FIG. 3, with identifiers which allow for an overall view, and to use them in the experiment software.

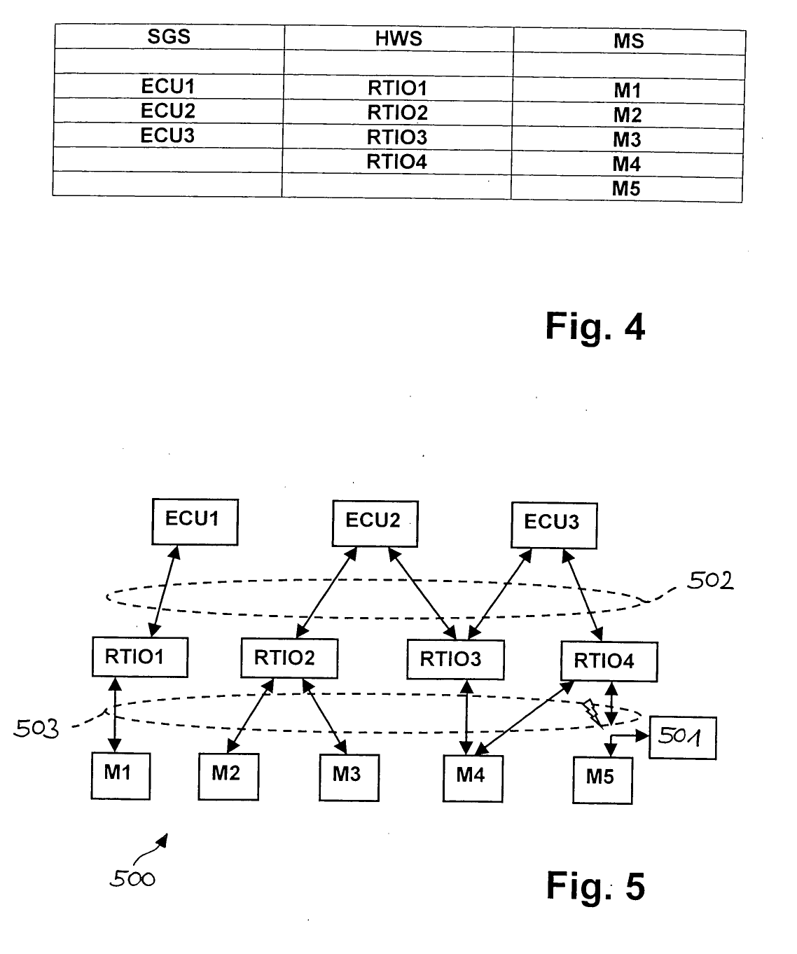

This information may then be presented to a user according to FIG. 4, in particular visualized, using further design capabilities, to thereby achieve the following:

Based on the scheme illustrated in FIG. 2, it is now possible to display the complete signal pattern on the basis of any input or output signal of one of the illustrated blocks. In other words, the user will receive a view of the entire signal pattern, including all ambiguities and branching points, upon calling a function. The user-assigned names of the signals at the inputs and outputs of the blocks shown in FIG. 2 serve as reference points therefor, as explained in greater detail below on the basis of FIGS. 3 through 5. It is further possible to display all signal values, i.e., visualize and represent them visually during an experiment conducted via the test system, on the basis of the view described in the previous point. It is further possible to intervene in the signal pattern and thus carry out a user-defined simulation of that particular signal, for example via a signal generator or a constant value, using predefined signal patterns in the view illustrated on the basis of the options in the first point. Finally, the blocks shown in FIG. 2, with the exception of the controller itself, may be parameterized or replaced by blocks that have the same input and output response. In particular, this includes a case in which the model of a component is replaced by a real component, e.g., the model of a throttle valve by a real throttle valve. The illustrated method and the system according to the present invention are independent of the development stage of the controller in FIG. 2, i.e., controller 200 may be either provided entirely as software or be built into a physical control unit, or combinations of the two options are conceivable.

FIG. 3 shows the signal flow or signal patterns and access to signals in a test system, in particular the LabCar system mentioned in the introduction. Simulation software 308 includes both simulation model 207 and experiment software 306. Component 300 to be tested, triggering the control processes, for example the control unit or regulator (hardware- or software-implemented), is connected to a block 301 of the hardware and a block 302 of the real-time input/output (real-time i/o). Corresponding to each signal direction, an open loop configuration OLC is optionally provided between block 302 and experiment software 306; blocks 303 and 304, depending on the signal direction. This open loop configuration, represented by blocks 303 and 304, is able to intervene in the signal path between the model and hardware and, for example, signals from a signal generator 305 or constant values may be supplied. This open loop configuration OLC is the intermediate layer between the model specification and the input/output hardware drivers. The open loop configuration has multiple functions. Its main function is to convert physical values into electrical ones (for signals from the vehicle model to the control unit) and to convert electrical values back into physical values (for signals transmitted from the control unit to the vehicle). This largely corresponds to the functions performed by sensors (physical into electrical) and actuators (electrical into physical) in the vehicle. Sensors and actuators are modeled in the open loop configuration, i.e., blocks 303 and 304.

### SENSOR EXAMPLE

The physical value of brake pressure=4.3 bar would be able to be converted by a sensor model of the OLC into the electrical value, i.e., voltage across a pressure sensor U_{Bake}=1.32 V.

### ACTUATOR EXAMPLE

The electrical value “pulse duty factor” in the pulse width modulation of an ABS valve, e.g., 0.789, would be able to be converted by an OLC actuator module into the physical value “flow rate”=0.24 liters per minute. The main function of modulating sensors and actuators is also the minimum requirement for an OLC. Because both the electrical and the physical values of every signal sent to or received from the control unit are present in the OLC, the latter is an ideal central point for performing user intervention in the signals. For this purpose, it is possible, in the case of both sensors and actuators, to influence the physical and electrical values in three different ways; directly, i.e., supplying the value 1:1; manually setting the value to a constant quantity; or stimulation, i.e., obtaining the value from a signal generator, which enables signal patterns to be predefined manually. This makes it possible to fully or partially decouple the physical vehicle model from real-time I/O (real-time input/output) 302 in that desired signals are predefinable. Control loops are thereby opened, and the control unit is no longer operated in a closed loop, either completely or in part, hence the name open loop configuration. This open loop configuration is defined in the signal properties. An OLC change may be made valid immediately for an experiment in progress. With regard to the signal pattern or signal flow in a test system of this type, there are three points according to the present invention where the signals and their properties are accessible to determine, visualize, or even change them. One such point is intervention point 312, i.e., the inputs and outputs of model software 308, in particular experiment software 306. At this point, the signals are called model signals MS.

Another intervention point is formed by the inputs and outputs of the open loop configuration or the real-time I/O at intervention points 311 and 310. At this point, the signals are called hardware signals HWS.

The third intervention option in this exemplary embodiment, i.e., the third intervention point, is formed by the inputs and outputs of the component triggering the control processes, i.e., in particular of control unit 300. This intervention point is designated 309, and the signals at this point are called control unit signals SGS. In principle, the model signals, hardware signals, and control unit signals are all part of the same signal pattern. The designations merely specify the intervention points in the overall signal path or signal pattern. Therefore, the signal paths or signal patterns to and from the control unit, the access points or intervention points therefor, and the points at which signals may be supplied from the signal generator or otherwise are illustrated in FIG. 3.

Through these means, therefore, in particular via the intervention points, signal flows or signal patterns are specifiable and trackable, i.e., from the simulation model via real-time input/output 302 to the control unit terminals and vice versa. Signal properties may also be determined and edited. According to the present invention this is done by assigning identifiers either to the intervention points themselves or to the signal resulting thereby.

This identifier assignment makes it possible to track a signal pattern over intervention points 309, 310, 311, and 312 and still process individual signals according to the intervention points. For this purpose, these signals are divided into signal groups according to the intervention points, as shown in the table in FIG. 4. In the case of intervention point 309, control unit signals SGS, which correspond, for example, to electronic control unit (ECU) pins, or ECUL through ECU3 in FIG. 4, are obtained. Multiple hardware signals, for example, are provided for different signal patterns in the case of real-time I/O 302 or downstream from the open-loop configuration, represented here as hardware signals HWS, RTI/O1 through RTI/04. Model signals MS, designated M1 through M5 in this example, are likewise used at intervention point 312. The number of individual signals in the signal groups is selected at random and largely depends on the signal patterns according to the test in question.

In FIG. 4, these signals may be represented visually, as shown in this table, an assignment also being made to the particular signal pattern of the individual signals. This is accomplished through identifiers, which are assigned either to the intervention points or to the individual signals.

A first possibility for such indicators is, for example, to provide ECU1 with an identifier K1, RTI/O2 with any identifier K1, K2, and M1 with an identifier K1, K2, K3. Via identifiers K1 and K2, it is possible to clearly track the signal path from ECU1 via RTI/O2 to M1, and the aforementioned advantages of visualizing the value display and intervention options are provided.

A further method of assigning identifiers is a logic operations graph 500, as shown in FIG. 5. This graph shows the signals according to the table in FIG. 4, ECU1 through ECU3, RTI/O1 through RTI/O4, and M1 through M5, once again by way of example. To simplify the representation, the directional arrows in this graph are selected in both directions. However, the signal direction may also be shown separately. The identifiers may be assigned either to the signals or the intervention points, 502 and 503 in this case, according to the paths on the logic operations graph. A simple path is, for example ECU1, RTI/O1 and M1, which are assigned an overall identifier 1, or separate identifiers which represent the different associations throughout the path run may be assigned in interfaces between ECU1 and RTI/O1 as well as RTI/O1 and M1. The same applies to the paths ECU2, RTI/O2, M2 or optionally ECU2, RTI/O2, M3 as well as ECU2, RTI/O3, M4 and ECU3, RTI/O3, M4 or ECU3, RTI/O4, M4. A signal interruption which has responded is shown in path ECU3, RTI/O4, M5, where a signal is injected at M5 via block 501. As mentioned above, this may be a signal from generator 305 or a constant value or a 1:1 supply. This intervention and interruption may also take place at intervention point 502. Intervention and visualization in the signal flow may thus be generated either by assigning unique identifiers according to the signal path or by using a path table for tracking the individual path. These intervention capabilities according to the intervention points may now be adjusted in the experiment paths and the paths may be modified by making identifiers variable, so that the signals in the experiment are assignable to different signal patterns. According to this embodiment, therefore, the signal patterns according to FIG. 2 may be visualized and routed for the user.

In addition to the system according to the present invention and the method according to the present invention for testing control processes in a vehicle, the present invention may also be designed as a computer program having program code that enables all steps according to the present invention to be carried out when the program is run on a computer. In particular, the identifier adaptation, identifier modification and, indeed, the provision of an intervention capability may be advantageously implemented by a computer program having program code.

On this basis, this computer program may, of course, also be implemented on a computer program product having program code that is stored on a machine-readable carrier and is used to carry out the method according to the present invention when the program is run on a computer. Machine-readable carriers of this type are, for example, memory modules such as EPROMs, flash EPROMs, ROMs, EEPROMs, etc., as well as CD-ROMs, DVDs, floppy disks and similar machine-readable carriers, as well as the ability to input the program into a computer system via text recognition. The present invention may therefore be used as a software product. In a test system used to validate developments in the automotive electronics sector, this makes it possible to visualize the signal patterns or signal loss via the test system and via the object waiting to be validated, and to display the values of these detected signals during a test, and to provide certain intervention capabilities in the signal pattern.

1-10. (canceled)

11. A system for testing a control process in a vehicle, comprising:
a component for triggering the control process;
a simulation model that responds to the control process to be tested;
an experiment software superimposed upon the simulation model;
an arrangement for forming a signal pattern between the experiment software and the component for triggering the control process;
an arrangement for dividing the signal pattern into at least two signals by at least two intervention points; and
an arrangement for providing at least one identifier that enables the at least two signals to be assigned to the signal pattern.

12. The system as recited in claim 11, wherein the intervention points are provided with identifiers.

13. The system as recited in claim 11, wherein the at least two signals are provided with identifiers.

14. The system as recited in claim 11, wherein the at least two signals are assigned to different signal groups.

15. The system as recited in claim 14, wherein the different signal groups are represented optically.

16. The system as recited in claim 13, wherein the identifiers are variable and enable the at least two signals to be assigned to different signal patterns.

17. The system as recited in claim 11, wherein a first signal that replaces another signal can be input into the signal pattern at least one intervention point.

18. A method for testing a control process in a vehicle, comprising:
providing a simulation model that responds to the control process to be tested;
superimposing an experiment software upon the simulation model;
forming a signal pattern between the experiment software and a component triggering for the control process;
dividing the signal pattern into at least two signals by using at least two intervention points, and
assigning the at least two signals to the signal pattern by at least one identifier.

19. A computer program having program code that when executed results in a performance of the following:
providing a simulation model that responds to a control process to be tested;
superimposing an experiment software upon the simulation model;
forming a signal pattern between the experiment software and a component triggering for the control process;
dividing the signal pattern into at least two signals by using at least two intervention points, and
assigning the at least two signals to the signal pattern by at least one identifier.

20. A computer program having program code that is stored on a machine-readable carrier and that when executed results in a performance of the following:
providing a simulation model that responds to a control process to be tested;
superimposing an experiment software upon the simulation model;
forming a signal pattern between the experiment software and a component triggering for the control process;
dividing the signal pattern into at least two signals by using at least two intervention points, and
assigning the at least two signals to the signal pattern by at least one identifier.
